(19) United States
(12) Patent Application Publication
(10) Pub. No.: US 2013/0155125 A1
(43) Pub. Date: Jun. 20, 2013

(54) DISPLAY APPARATUS AND CONTROL METHOD THEREOF

(71) Applicant: CANON KABUSHIKI KAISHA, tokyo (JP)

(72) Inventor: Kohei Inamura, Sagamihara-shi (JP)

(73) Assignee: CANON KABUSHIKI KAISHA, Tokyo (JP)

(21) Appl. No.: 13/716,650

(22) Filed: Dec. 17, 2012

(30) Foreign Application Priority Data
Dec. 19, 2011 (JP) 2011-277626
Nov. 26, 2012 (JP) 2012-257481

(51) Int. Cl. G09G 5/10

(52) U.S. Cl. CPC G09G 5/10
USPC 345/690; 345/102

(57) ABSTRACT

A display apparatus comprises a determination unit and a control unit, wherein when a block corresponding to an object region is not included in a predetermined number of blocks centered around a determination-target block, the determination unit determines that the determination-target block is a block which satisfies a predetermined condition, and wherein the control unit: sets a backlight emission brightness of a block corresponding to the object region to a first level, sets a backlight emission brightness of a block which satisfies the predetermined condition, among the blocks corresponding to a background region, to a second level that is lower than the first level, and sets a backlight emission brightness of a block which does not satisfy the predetermined condition, among the blocks corresponding to the background region, to a third level that is higher than the second level and not higher than the first level.

### BACKGROUND OF THE INVENTION

1. Field of the Invention

The present invention relates to a display apparatus and a control method thereof.

2. Description of the Related Art

In recent years, in a display apparatus (liquid crystal display apparatus) which uses liquid crystals, there is technology of controlling the backlight emission brightness (the emission brightness of a backlight) according to the input image signal for each block obtained by dividing an image or a screen. Moreover, there is technology of controlling the backlight emission brightness according to the input image signal for each block, and correcting the image signal according to the level of that backlight emission brightness. These technologies are referred to as local dimming, and, by using local dimming, it is possible to improve the contrast of the display image and inhibit the misadjusted black level.

Conventional technology related to local dimming is disclosed, for example, in Japanese Patent Application Publication No. 2008-51905. Specifically, Japanese Patent Application Publication No. 2008-51905 discloses that, in a region of a given length which is adjacent to blocks in which the their backlight is turned on, the backlight is caused to emit light at a backlight emission brightness that is lower than the backlight emission brightness of the foregoing blocks in which their backlight is turned on. As a result of using the technology disclosed in Japanese Patent Application Publication No. 2008-51905, it is possible to inhibit the generation of an unnatural misadjusted black level.

### SUMMARY OF THE INVENTION

As described above, with local dimming, the backlight emission brightness is controlled according to the input image signal for each block. Thus, when the input image signal contains an object region (region containing a specific object) that needs to be displayed favorably, if local dimming is used, there are cases where the image of the object region cannot be displayed favorably. For example, there are cases where it is not possible to display an image that is faithful to the input image signal, in the object region. Specifically, when the object region crosses over a plurality of blocks, due to the difference in the backlight emission brightness, there are cases where variation arises in the brightness (brightness on the screen; display brightness) in the object region.

Here, if image processing according to the backlight emission brightness is performed to the input image signal for each block, it is possible to approximate the display image to an image that is faithful to the input image signal. Nevertheless, the foregoing image processing generally contains errors. Thus, even if image processing is performed to input image signal according to the backlight emission brightness, it is not possible to display an image that is faithful to the input image signal.

Moreover, while the image of object region can be displayed in a manner that is faithful to the input image signal if local dimming is not used, the effect of contrast improvement yielded by local dimming cannot be obtained.

Thus, the invention provides technology capable of improving the contrast of the display image, and favorably displaying the image of the object region.

A display apparatus according to the present invention is

a display apparatus capable of controlling a backlight emission brightness for each block obtained by dividing an image,

the display apparatus comprising:

a determination unit that determines, for each block corresponding to a background region, which is a region of a background in an image based on an input image signal, whether the block is a block which satisfies a predetermined condition; and

a control unit that controls the backlight emission brightness of each of the blocks based on a determination result of the determination unit, wherein

when a block corresponding to an object region, which is a region of a predetermined object in an image based on an input image signal, is not included in a predetermined number of blocks centered around a determination-target block, the determination unit determines that the determination-target block is a block which satisfies the predetermined condition, and wherein

the control unit:

sets a backlight emission brightness of a block corresponding to the object region to a first level,

sets a backlight emission brightness of a block which satisfies the predetermined condition, among the blocks corresponding to the background region, to a second level that is lower than the first level, and

sets a backlight emission brightness of a block which does not satisfy the predetermined condition, among the blocks corresponding to the background region, to a third level that is higher than the second level and not higher than the first level.

A control method of a display apparatus according to the present invention is

a control method of a display apparatus capable of controlling a backlight emission brightness for each block obtained by dividing an image,

the method comprising:

a determination step of determining, for each block corresponding to a background region, which is a region of a background in an image based on an input image signal, whether the block is a block which satisfies a predetermined condition; and

a control step of controlling the backlight emission brightness of each of the blocks based on a determination result in the determination step, wherein

in the determination step, when a block corresponding to an object region, which is a region of a predetermined object in an image based on an input image signal, is not included in a predetermined number of blocks centered around a determination-target block, determination is made that the determination-target block is a block which satisfies the predetermined condition, and wherein

in the control step, a backlight emission brightness of a block corresponding to the object region is set to a first level,

a backlight emission brightness of a block which satisfies the predetermined condition among the blocks corresponding to the background region is set to a second level that is lower than the first level, and

a backlight emission brightness of a block which does not satisfy the predetermined condition among the blocks corresponding to the background region is set to a third level that is higher than the second level and not higher than the first level.

According to the present invention, it is possible to improve the contrast of the display image, and favorably display the image of the object region.

Further features of the present invention will become apparent from the following description of exemplary embodiments with reference to the attached drawings.

### BRIEF DESCRIPTION OF THE DRAWINGS

FIG. 1 is a block diagram showing an example of the functional configuration of the liquid crystal display apparatus according to Embodiment 1;

FIG. 2A is a diagram showing an example of the image signal;

FIG. 2B is a diagram showing an example of the processing result of the lighting influence evaluation;

FIG. 3 is a diagram showing an example of the diffusion of light from the backlight;

FIGS. 4A to 4C are diagram showing an example of the distribution of brightness of the backlight;

FIG. 5 is a diagram showing an example of the lighting influence table;

FIG. 6 is a flowchart showing an example of the processing flow of the lighting influence evaluation unit according to Embodiment 1;

FIG. 7 is a block diagram showing an example of the functional configuration of the liquid crystal display apparatus according to Embodiment 2;

FIG. 8 is a flowchart showing an example of the processing flow of the lighting influence evaluation unit according to Embodiment 2;

FIG. 9 is a diagram showing an example of the distribution of brightness of the backlight;

FIG. 10 is a block diagram showing an example of the functional configuration of the liquid crystal display apparatus according to Embodiment 3;

FIG. 11 is a block diagram showing an example of the functional configuration of the liquid crystal display apparatus according to Embodiment 4; and

FIG. 12A and FIG. 12B are diagrams showing an example of the processing result of the lighting influence evaluation according to Embodiment 1.

### DESCRIPTION OF THE EMBODIMENTS

### Embodiment 1

The display apparatus and its control method according to Embodiment 1 of the present invention are now explained. The display apparatus according to this embodiment is a display apparatus capable of controlling the backlight emission brightness (the emission brightness (emission luminance) of the backlight) for each block that is obtained by dividing an image or a screen. For example, a block is a region that is obtained by dividing an image to display. For example, a block is a region that is obtained by dividing the image N times in the horizontal direction (N is an integer of 2 or higher) and dividing the image M times in the vertical direction (M is an integer of 2 or higher). Note that a block may be a region that is obtained by dividing the image only in the horizontal direction, or a region that is obtained by dividing the image only in the vertical direction.

In this embodiment, explained is a case where the display apparatus includes, as the operation mode, a dimming ON mode and a dimming OFF mode. The dimming ON mode is an operation mode for controlling the backlight emission brightness for each block. The dimming OFF mode is an operation mode for mutually equalizing the backlight emission brightness of all blocks.

Moreover, in this embodiment, explained is a case where the display apparatus is a liquid crystal display apparatus comprising a liquid crystal panel and a backlight. However, the display apparatus is not limited to a liquid crystal display apparatus. The display apparatus may be any display apparatus so as long as it is a display apparatus that displays images by using the light from a light source.

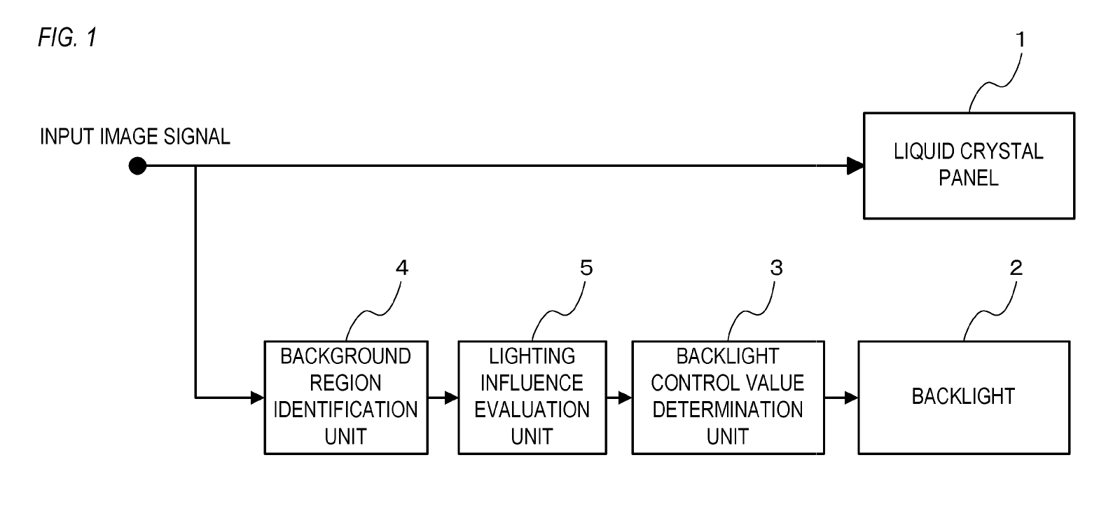

FIG. 1 is a block diagram showing an example of the functional configuration of the liquid crystal display apparatus according to this embodiment.

The liquid crystal panel 1 is a transmission liquid crystal panel comprising a plurality of liquid crystal elements in which the transmittance is controlled based on image signals. The image signal (input image signal) that is input to the liquid crystal panel 1 is also input to the background region identification unit 4.

The backlight 2 is an illuminating apparatus comprising a light source (one or more light sources) for each block, and illuminates the rear face of the liquid crystal panel 1. The light source of the respective blocks can be controlled independently. The backlight emission brightness (the emission brightness of the backlight 2) of the respective blocks is controlled by the backlight controlling value determination unit 3. An image is displayed on the screen as a result of the backlight emission light (the light emitted from the backlight 2) being transmitted through the liquid crystal panel 1.

When the operation mode is the dimming ON mode, the background region identification unit 4 determines, for each block, whether that block is a block corresponding to the background region, which is a region of the background in the image based on the input image signal.

In this embodiment, it is assumed that the background region is a region that is darker than the region (object region) of a predetermined object. The input image signal is, for example, a black-and-white diagnosis image taken via X-ray photography, and includes an object region (diagnosis region) which is a region of the person to be diagnosed, and the remaining black background region. This kind of object region is a region that needs to be displayed favorably. For example, the object region is a region that is displayed in white or gray and needs to be displayed in a manner that is faithful to the input image signal.

The background region identification unit 4 counts, for each block, the number of pixels having a pixel value that is a threshold Th1 or less (predetermined value or less) of the input image signal displayed in that block. In addition, the background region identification unit 4 determines that a block in which the counted value is a predetermined value or less; that is, a block in which the input image signal to be displayed contains a predetermined number of pixels or more having a pixel value that is a threshold Th1 or less, as the block corresponding to the background region. In this embodiment, the brightness value is used as the pixel value to be compared with the threshold Th1. As the threshold Th1, for example, a brightness value that becomes 5% when the maximum brightness is 100% is set in advance (however, this is not limited to 5%, and the brightness value may also be set to other arbitrary values such as 10% or 3%).

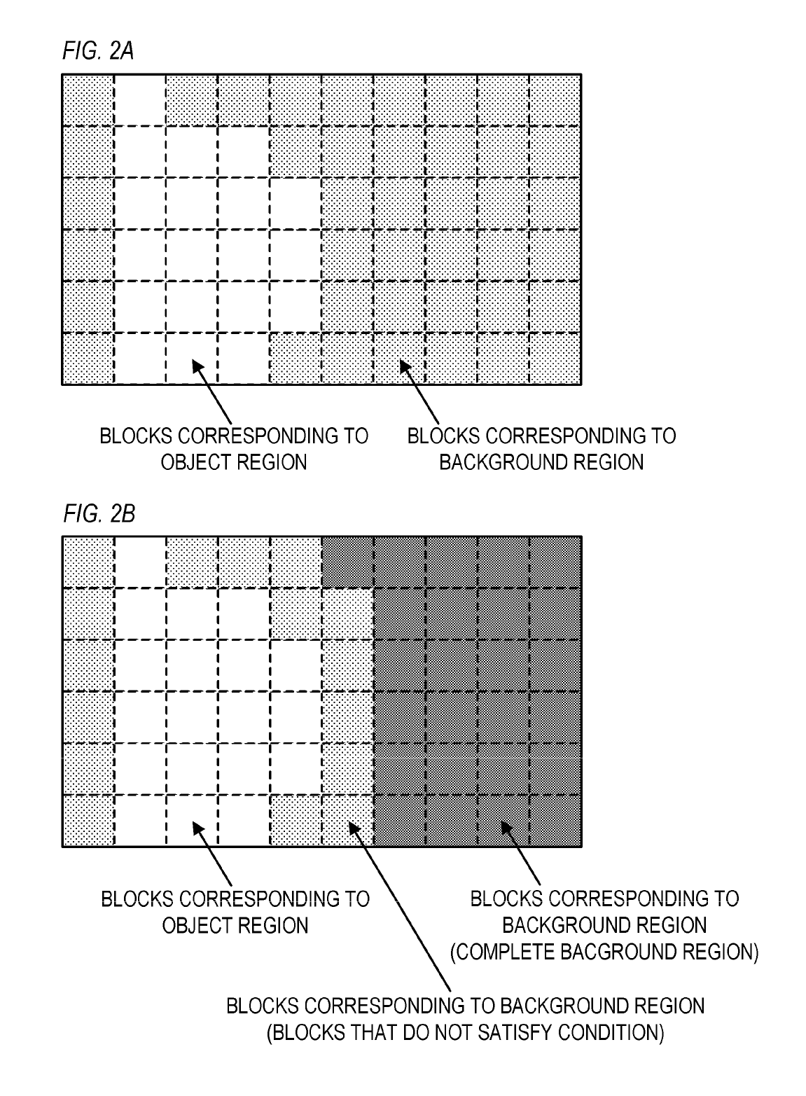

FIG. 2A shows an example of the image signal. In FIG. 2A, each region partitioned with a broken line is a block. Moreover, in FIG. 2A, the white blocks are a region with a high pixel value, and the blocks shown with dots are a region with a low pixel value. In the example of FIG. 2A, the blocks shown with dots are determined to be the blocks corresponding to the background region.

The background region identification unit 4 sets 1 in the background flag BkFLG of the block that was determined as a block corresponding to the background region. For example, when a block in which the position in the horizontal direction is i and the position in the vertical direction is j is determined as a block corresponding to the background region, 1 is set in the background flag BkFLG(i, j). 0 is set in the background flag BkFLG of the other blocks (blocks that were not determined as a block corresponding to the background region).

The method of determining whether a block is a block corresponding to the background region is not limited to the foregoing method. For example, a block in which the representative value (maximum pixel value, average pixel value, modal pixel value or the like) of the pixel value is a predetermined value or less may be determined as a block corresponding to the background region. A block in which the pixel value is concentrated in a certain pixel value may be determined as a block corresponding to the background region. Moreover, blocks in which all adjacent blocks are blocks corresponding to the background region (blocks determined as block corresponding to the background region with the foregoing determination method) may be determined as blocks corresponding to the background region (isolated point elimination processing). It is thereby possible to eliminate the influence of the noise contained in the background region.

The lighting influence evaluation unit 5 receives a background flag BkFLG from the background region identification unit 4. In addition, when the operation mode is the dimming ON mode, the lighting influence evaluation unit 5 determines, for each block corresponding to the background region, whether that block satisfies a predetermined condition. In this embodiment, a block in which the backlight emission light does not affect the flatness of backlight brightness (brightness (luminance) of the backlight 2) of the blocks corresponding to the object region is determined as a block satisfying the foregoing predetermined condition (complete background region). Specifically, the lighting influence evaluation unit 5 determines blocks (blocks other than the blocks corresponding to the background region) which were determined by the background region identification unit 4 as not being the blocks corresponding to the background region as the blocks corresponding to the object region. In addition, when a block corresponding to the object region is not included in a predetermined number of blocks centering around the determination-target block (block to be subject to the determination of whether it is a complete background region), the lighting influence evaluation unit 5 determines that the determination-target block is a complete background region. The lighting influence evaluation unit 5 sets 1 in the complete background flag CBkFLG of the block determined as being a complete background region. For example, when a block in which the position in the horizontal direction is i and the position in the vertical direction is j is determined as a complete background region, 1 is set in the complete background flag CBkFLG(i, j). 0 is set in the complete background flag CBkFLG of the other blocks that were not determined as a complete background region. The determination method will be explained later in detail.

When the operation mode is the dimming ON mode, the backlight controlling value determination unit 3 controls the backlight emission brightness of the respective blocks based on the determination result of the lighting influence evaluation unit 5.

Specifically, when the operation mode is the dimming ON mode, the backlight controlling value determination unit 3 determines, as a block corresponding to the object region, a block that was determined by the background region identification unit 4 as not being a block corresponding to the background region. In addition, the backlight controlling value determination unit sets the backlight emission brightness of the blocks corresponding to the object region to a first level. Thus, when a plurality of blocks are determined as blocks corresponding to the object region, the backlight emission brightness of all blocks determined as being blocks corresponding to the object region will be mutually equalized. Consequently, variation in the brightness (brightness (luminance) on the screen; display brightness) in the object region caused by the difference in the backlight emission brightness can be reduced. Note that the first level is preferably a sufficiently high brightness level. Consequently, the diagnosis of the image of the object region (diagnosis region) is facilitated.

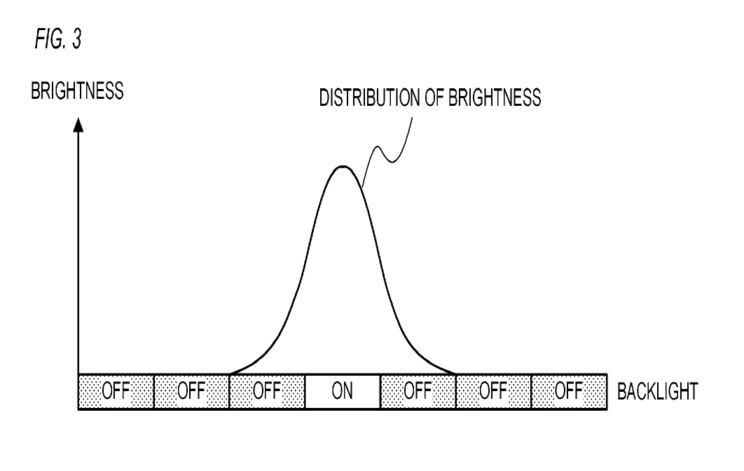

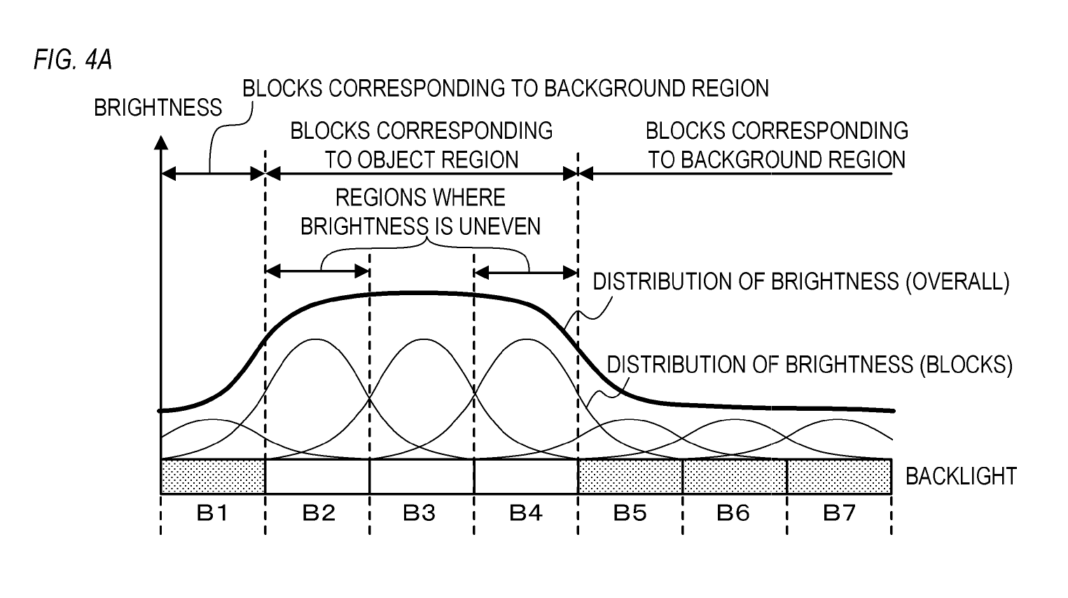

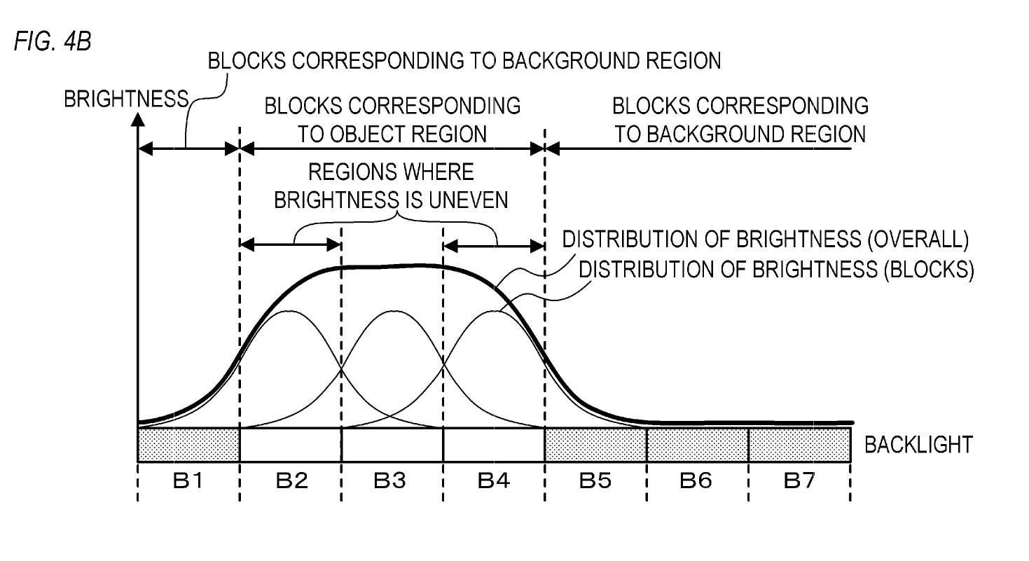

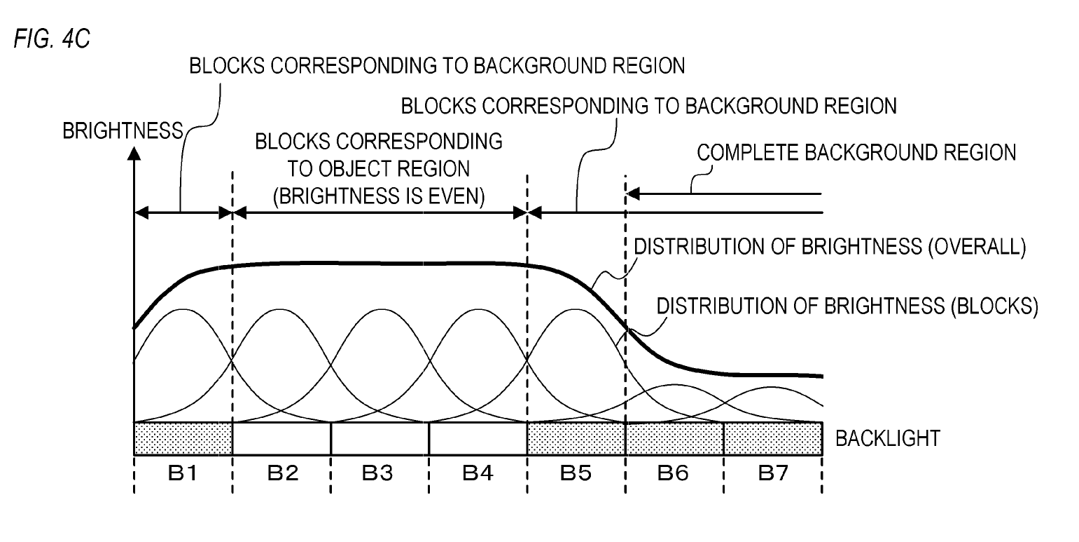

Here, if the backlight emission brightness of the block that was determined by the background region identification unit 4 as being a block corresponding to the background region is set to be lower than the backlight emission brightness of the blocks corresponding to the object region, the contrast of the display image can be improved (occurrence of a misadjusted black level can be inhibited). Nevertheless, when this kind of control is performed, there are cases where the object region cannot be displayed favorably. This is now explained with reference to FIGS. 3 and 4A to 4C.

FIG. 3 is a diagram showing an example of the backlight emission light diffusing and leaking to the other blocks when the light source (the light source of the backlight 2) of one block is lit.

FIGS. 4A to 4C are diagrams showing an example of the distribution (thin line (solid line)) of backlight brightness of the respective blocks and the distribution (heavy line (solid line)) of brightness of the overall backlight. In FIGS. 4A to 4C, reference numerals B1 to B7 represent blocks. Blocks B1, B5, B6, B7 are blocks corresponding to the background region, and blocks B2, B3, B4 are blocks corresponding to the object region. In this embodiment, while the plurality of blocks are arranged two-dimensionally (in a matrix), for the explanation of FIGS. 4A to 4C, it is assumed that the plurality of blocks are arranged one-dimensionally.

In a case where the backlight emission light of one block leaks to the other blocks, if the backlight emission brightness of all blocks determined as being a block corresponding to the background region is set to be lower than the backlight emission brightness of the blocks corresponding to the object region, there are cases where the backlight brightness of the object region becomes uneven. For example, as shown in FIG. 4A, there are cases where the backlight brightness of the blocks B2, B4 at the outermost edge among the blocks corresponding to the object region becomes non-flat (becomes dark toward the block corresponding to the background region side). When this kind of unevenness in brightness occurs, variation arises in the display brightness in the object region, and the image of the object region cannot be favorably displayed. This kind of unevenness in brightness becomes prominent, as shown in FIG. 4A and FIG. 4B, as the difference in the backlight emission brightness of the blocks corresponding to the background region and the backlight emission brightness of the blocks corresponding to the object region increases.

Thus, in this embodiment, the backlight controlling value determination unit 3 causes the backlight emission brightness of the blocks, among the blocks corresponding to the background region, in which the backlight emission light will affect the flatness of backlight brightness of the blocks corresponding to the object region to be equal to the backlight emission brightness of the blocks corresponding to the object region. Consequently, as shown in FIG. 4C, the backlight brightness of the object region can be made uniform.

Specifically, the backlight controlling value determination unit 3 sets the backlight emission brightness of the blocks (blocks in which CBkFLG is 1) determined as being a complete background region among the blocks corresponding to the background region to a second level that is lower than the first level. Moreover, the backlight controlling value determination unit 3 sets the backlight emission brightness of the blocks that were determined as not being a complete background region (as being blocks that do not satisfy the predetermined condition) among the blocks corresponding to the background region to a third level (=first level). More specifically, the backlight controlling value determination unit 3 sets the backlight controlling value of the blocks which are a complete background region to Bk, and sets the backlight controlling value of the other blocks to W. The backlight controlling value is a value that represents the backlight emission brightness, and the backlight controlling value Bk represents a backlight emission brightness that is lower than the backlight controlling value W (that is, Bk<W). The backlight 2 causes, for each block, the light source of that block to emit light based on the backlight emission brightness according to the backlight controlling value of that block.

The backlight controlling value W is, for example, the backlight controlling value of the respective blocks during the dimming OFF mode.

The backlight controlling value Bk is, for example, a value that is set forth by the manufacturer based on the input image signal as the background region in order to inhibit the misadjusted black level of the background region. If a value that represents ⅕ the backlight emission brightness of the backlight emission brightness represented by the backlight controlling value W is used as the backlight controlling value Bk, in a pattern that improves the contrast the most, the contrast can be improved fivefold in comparison to the case during the dimming OFF mode. Note that the backlight controlling value Bk may also be changed by the user. Moreover, when the liquid crystal display apparatus includes an installation environment brightness detection unit for detecting the peripheral brightness of the liquid crystal display apparatus, the backlight controlling value Bk may also be calculated according to the peripheral brightness of the liquid crystal display apparatus. Moreover, the backlight controlling value Bk may also be calculated individually based on the input image signal for each block corresponding to the background region. For example, stored in advance may be a function (table) representing the correspondence relation of the brightness value (average brightness value (average pixel value), modal brightness value (modal pixel value), minimum brightness value (minimum pixel value), maximum brightness value (maximum pixel value) or the like) of the input image signal, and the backlight controlling value. In addition, the backlight controlling value Bk may also be calculated individually based on the foregoing function and input image signal for each block corresponding to the background region.

Note that, in this embodiment, when the operation mode is the dimming ON mode, the configuration is such that the backlight controlling value of all blocks determined as being a complete background region is set to the first setting value (Bk), and the backlight controlling value of all other blocks is set to the second setting value (W). Nevertheless, the configuration of the present invention is not limited thereto. For example, the configuration may also be such that the foregoing processing is performed only when the operation mode is the dimming ON mode, and the plurality of blocks are determined by the background region identification unit 4 as not being blocks corresponding to the background region. In a case where the operation mode is the dimming ON mode, if there is only one block that is determined by the background region identification unit 4 as not being a block corresponding to the background region, the backlight emission brightness of all blocks may be respectively controlled based on the input image signal.

Moreover, the liquid crystal display apparatus does not need to comprise the dimming OFF mode as the operation mode.

The operation of the lighting influence evaluation unit 5 is now explained in detail.

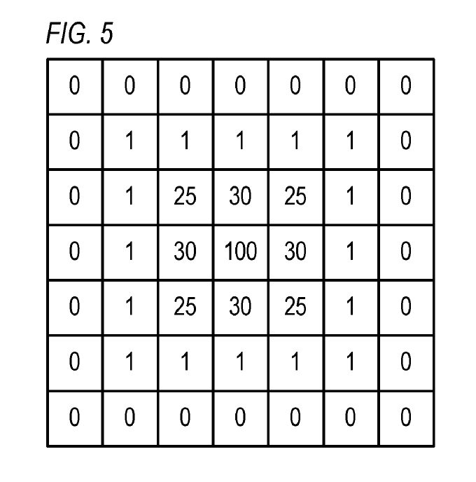

The lighting influence evaluation unit 5 stores a lighting influence table in advance. The lighting influence table represents, for each block, the influence level of the backlight emission light of that block to the peripheral blocks. An example of the lighting influence table of a determination-target block (block to be subject to the determination of whether it is a complete background region) is shown in FIG. 5.

The lighting influence evaluation unit 5 uses the lighting influence table and determines that the determination-target block is a complete background region when a block corresponding to the object region is not included in the blocks in which the influence level of light is greater than a predetermined threshold Th2.

In the example of FIG. 5, the lighting influence table shows the backlight brightness when only the light source of the block to be processed is light regarding each of the 7×7 blocks centered around the determination-target block. The numerical values indicated in the respective blocks show the ratio of backlight brightness of that block (ratio of backlight brightness of that block to the backlight brightness of the determination-target block). Specifically, in the example of FIG. 5, with the backlight brightness of the determination-target block as 100%, the backlight brightness of the four blocks adjacent above, below, left and right of the determination-target block is 30%. The backlight brightness of the four blocks adjacent obliquely to the block to be processed is 25%. The backlight brightness of the sixteen blocks adjacent around (outer periphery) the foregoing eight blocks is 1%. The backlight brightness of the twenty-four blocks adjacent around (outer periphery) the foregoing sixteen blocks is 0%. In other words, the backlight brightness of the foregoing twenty-four blocks is not affected by the backlight emission light of the determination-target block.

Accordingly, if the threshold Th2 is set to 5%, when the determination-target block and all eight blocks adjacent in the vertical, horizontal and oblique directions of the determination-target block are blocks corresponding to the background region, the determination-target block is determined to be a complete background region. As a result of lowering the backlight emission brightness of the complete background region among the blocks corresponding to the background region, it is possible to inhibit the reduction in flatness of backlight brightness of the blocks corresponding to the object region, and additionally improve the contrast.

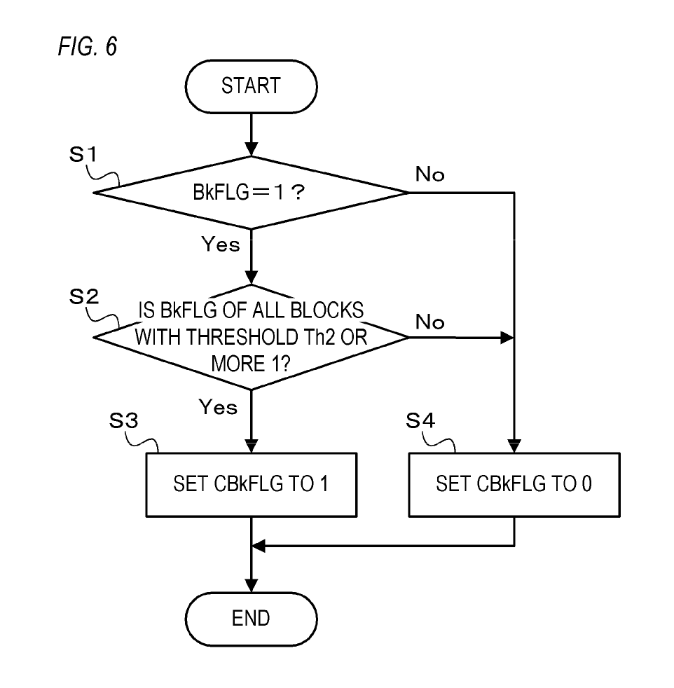

The processing flow of the lighting influence evaluation unit 5 is now explained with reference to FIG. 6. The following processing flow is performed for each block.

Foremost, the lighting influence evaluation unit 5 determines whether the background flag BkFLG of the block to be processed is 1 (step S1).

When the background flag BkFLG of the block to be processed is 1, the lighting influence evaluation unit 5 determines that the block to be processed is a block corresponding to the background region, and the processing proceeds to step S2. When the background flag BkFLG of the block to be processed is 0, the lighting influence evaluation unit 5 determines that the block to be processed is a block corresponding to the object region, and the processing proceeds to step S4.

In step S2, the lighting influence evaluation unit 5 refers to the lighting influence table of the block to be processed, and determines whether a block in the lighting influence table having a value that is greater than the threshold Th2 is a block corresponding to the background region. This determination is performed by confirming the background flag BkFLG of a block having a value that is greater than the threshold Th2.

When all blocks having a value that is greater than the threshold Th2 are blocks corresponding to the background region, the lighting influence evaluation unit 5 determines that the block to be processed is a complete background region, and the processing proceeds to step S3.

When a block other than the blocks corresponding to the background region is included in the blocks having a value that is greater than the threshold Th2, the lighting influence evaluation unit 5 determines that the block to be processed is not a complete background region, and the processing proceeds to step S4.

Instep S3, the lighting influence evaluation unit 5 sets 1 in the complete background flag CBkFLG of the block to be processed.

Instep S4, the lighting influence evaluation unit 5 sets 0 in the complete background flag CBkFLG of the block to be processed.

The lighting influence evaluation unit 5 performs the foregoing processing to all blocks, and outputs the complete background flag CBkFLG of all blocks.

FIG. 2B is a diagram showing an example of the results of the foregoing processing of the lighting influence evaluation.

Note that, when the backlight characteristics (the characteristics of the backlight 2) of the respective blocks are basically the same, the range of P×P (P is an integer of 3 or higher) number of blocks centered around the block to be processed may be stored as the influential range. In addition, when all blocks in the influential range are blocks corresponding to the background region, the block to be processed may be determined as being a complete background region. To put it differently, when a block corresponding to the object region is not included in the blocks in the influential range, the block to be processed may be determined as being a complete background region. For example, when the threshold Th2 is 0, the range of 5×5 of FIG. 5 may be set as the influential range, and when the threshold Th2 is 1%, the range of 3×3 of FIG. 5 may be set as the influential range. Moreover, the range of k×1 (k≧1, 1≧1) number of blocks centered around the block to be processed may be stored as the influential range. As a result of storing the influential range in advance, the determination of whether a block is a complete background region can be performed easier since there is no need to determine, for each block, whether that block has a value that is greater than the threshold Th2.

As described above, according to this embodiment, during the dimming ON mode, among the blocks corresponding to the background region, a block in which the backlight emission light does not affect the flatness of backlight brightness of the blocks corresponding to the object region is identified as a complete background region. In addition, among the blocks corresponding to the background region, the backlight emission brightness of the blocks other than the complete background region (blocks in which the backlight emission light will affect the fatness of backlight brightness of the blocks corresponding to the object region) and the blocks corresponding to the object region is set to the first level. Consequently, the backlight emission brightness of the object region can be made uniform, variation in the brightness (brightness on the screen; display brightness) in the object region can be inhibited, and the image of the object region can be favorably displayed. Moreover, according to this embodiment, during the dimming ON mode, the backlight emission brightness of the complete background region is set to a second level that is lower than the first level. Consequently, the contrast of the display image can be improved.

Note that, when the backlight emission brightness of the block is decreased, the image cannot be displayed with the display brightness according to the input image signal unless signal correction processing of extending the signal is performed to the pixel value of that block.

In this embodiment, the backlight controlling value of the complete background region is set to a fixed value Bk, the backlight emission brightness of that block is decreased, and signal correction processing is not performed. This is because, in a complete background region, priority is given to the improvement of contrast (inhibition of misadjusted black level), and the deterioration in gradation reproducibility (signal fidelity) is tolerated. Moreover, the reason why the foregoing signal correction processing is not performed to the block corresponding to the object region is in order to display an image that is faithful to the input image signal. Nevertheless, the present invention is not limited to this configuration. For example, the foregoing signal correction processing may be performed to the image signal of the complete background region so that the display brightness becomes the display brightness according to the input image signal. With this kind of configuration, while the effect of contrast improvement will decrease in comparison to the case of not performing the foregoing signal correction processing, the gradation reproducibility of the complete background region will improve. Moreover, signal correction processing may be performed to the image signal of the complete background region to reduce the gradation value (reduce it to 0). With this kind of configuration, while the gradation of the complete background region will collapse, the visibility of the object region can be improved.

Note that, in this embodiment, while the backlight emission brightness (third level) of the blocks other than the complete background region among the blocks corresponding to the background region was caused to be equal to the backlight emission brightness (first level) of the blocks corresponding to the object region, the present invention is not limited to this configuration. The third level will suffice so as long as it is a level that is higher than the second level (backlight emission brightness of the complete background region) and not higher than the first level. Then the third level is set to this kind of level, it is possible to improve the flatness of backlight brightness of the object region, and favorably display the image of the object region.

Moreover, among the blocks corresponding to the object region, there are cases where there is a block in which the area of the image of the displayed object region is small (block in which the area of the image of the displayed background region is large). In such a case, if the backlight emission brightness is controlled so that the backlight brightness of the overall object region becomes flat, the size of the portion that is subject to a misadjusted black level in the background region will increase. In order to inhibit the generation of a misadjusted black level, the backlight emission brightness of the blocks determined as not satisfying the predetermined condition should be controlled according to the area of the image of the object region that is displayed in the blocks corresponding to the object region among the predetermined number of blocks centered around that block. Specifically, the backlight emission brightness of the blocks determined as not satisfying the predetermined condition should be controlled to be a level that is lower than in a case where an area of the image of the object region displayed in the blocks corresponding to the object region among the predetermined number of blocks centered around that block is large when the area is small. For example, the level may be continuously or gradually changed so that the level becomes lower as the area of the image of the object region is smaller. Specifically, the backlight emission brightness may be set to a fourth level when the area of the image of the object region is a predetermined value or higher, and the backlight emission brightness may be set to a fifth level that is lower than the fourth level when the area of the image of the object region is less than a predetermined value (two-stage switching). Note that the switching is not limited to two stages. For example, the switching may also be three-stage switching, four-stage switching, five-stage switching or the like. The fourth level and the fifth level are levels that are higher than the second level and not higher than the first level. The fourth level is, for example, a level in which the backlight brightness of the overall object region becomes flat. The fifth level is a level capable of inhibiting the occurrence of a misadjusted black level. Moreover, the backlight emission brightness of the blocks determined as not satisfying the predetermined condition may also be controlled to be a level that is lower than in a case where an area of the image of the object region displayed in the blocks corresponding to the object region adjacent to that block is large when the area is small. With this kind of configuration also, it is possible to inhibit the occurrence of a misadjusted black level.

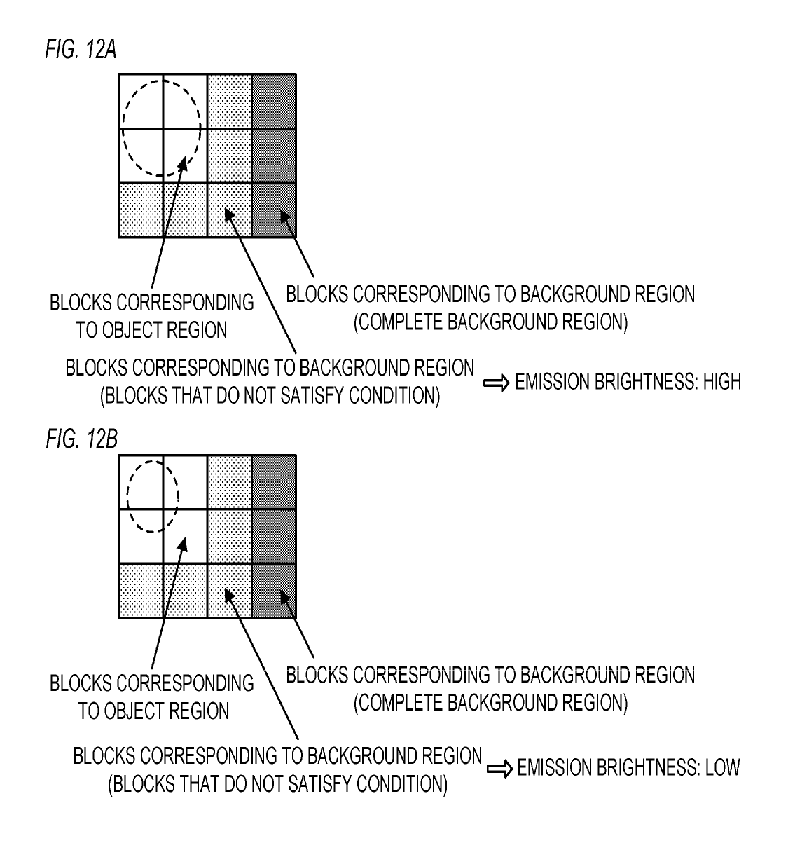

FIG. 12A and FIG. 12B show an example of the processing result of the lighting influence evaluation. The region surrounded by the broken line of FIG. 12A and FIG. 12B is the object region. In FIG. 12B, the area of the image of the object region displayed in the block corresponding to the object region among the predetermined number of blocks (eight blocks that are adjacent in the vertical, horizontal and oblique directions) centered around the block that was determined as not satisfying the predetermined condition is smaller than FIG. 12A. Thus, in FIG. 12B, the backlight emission brightness of the block that was determined as not satisfying the predetermined condition is set to a level that is lower than FIG. 12A.

As a result of performing this kind of control, it is possible to inhibit the occurrence of a misadjusted black level (possible to improve the contrast) at a portion near the object region in the background region while maintaining the flatness of backlight brightness of the overall object region.

Moreover, the backlight emission brightness of the blocks determined as not satisfying the predetermined condition may also be set to a second level when the area of the image of the object region displayed in the block corresponding to the object region among the predetermined number of blocks centered around the block that was determined as not satisfying the predetermined condition is small. The backlight emission brightness of the blocks determined as not satisfying the predetermined condition may also be set to a second level when the area of the image of the object region displayed in the block corresponding to the object region adjacent to that block is small. With this kind of configuration also, it is possible to inhibit the occurrence of a misadjusted black level.

Note that, in this embodiment, the background region was darker than the object region, but the background region is not limited thereto. For example, the flat region with minimal edge may be used as the background region regardless of the brightness.

### Embodiment 2

The display apparatus and its control method according to Embodiment 2 of the present invention are now explained. The display apparatus according to this embodiment determines whether a block is a block corresponding to the background region based on information (object region information) representing the display region of the image of the object region that is input from an external apparatus.

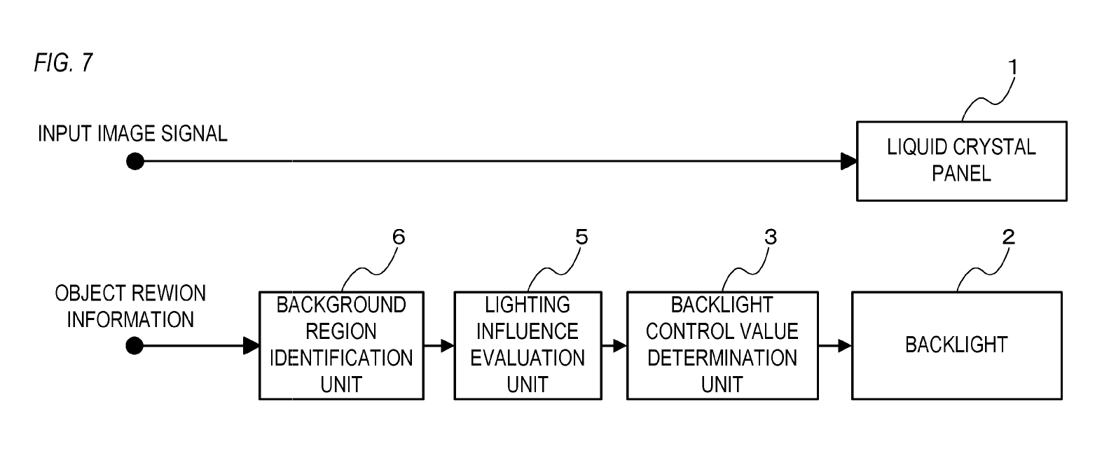

FIG. 7 is a block diagram showing an example of the functional configuration of the liquid crystal display apparatus according to this embodiment. The same reference numeral is given to the same function as Embodiment 1 (FIG. 1), and the explanation thereof is omitted.

The background region identification unit 6 determines a block in which an image of the object region is not displayed as the block corresponding to the background region based on the object region information that is input from an external apparatus. In addition, as with the background region identification unit 4 of Embodiment 1, the background region identification unit 6 sets 1 in the background flag BkFLG of the block that is determined as a block corresponding to the background region, and sets 0 in the background flag BkFLG of other blocks (blocks in which the image of the object region is displayed).

As explained above, according to this embodiment, a block in which an image of the object region is not displayed is determined as the block corresponding to the background region based on the object region information that is input from an external apparatus. In addition, as with Embodiment 1, a block other than the blocks corresponding to the background region is determined as a block corresponding to the object region. In other words, a block containing the display region of the image of the object region that is represented by the object region information input from an external apparatus is determined as a block corresponding to the object region. Thus, a block corresponding to the object region can be detected with greater accuracy in comparison to the case of determining all blocks other than the blocks corresponding to the background region detected based on the input image signal as being the blocks corresponding to the object region.

Note that the object region information may be information which represents a region in pixel units, or information which represents a region in block units. For example, an object region flag ObjFLG may be input for each block as the object region information. The object region flag ObjFLG is information showing whether a block is a block corresponding to the object region.

When 1 is set in the object region flag ObjFLG of the block corresponding to the object region and 0 is set in the object region flag ObjFLG of the other blocks, the background region identification unit 6 may directly output, as the determination result, the input object region information to the lighting influence evaluation unit 5. In addition, the lighting influence evaluation unit 5 may determine a block in which the object region flag ObjFLG is 0 as a block corresponding to the background region, and a block in which the object region flag ObjFLG is 1 as a block corresponding to the object region, and then perform the same processing as Embodiment 1. Note that when the object region flag ObjFLG is input for each block as the object region information, the liquid crystal display apparatus does not need to comprise the background region identification unit 6. The object region information may also be directly input from the external apparatus to the lighting influence evaluation unit 5. In addition, the lighting influence evaluation unit 5 may use the object region information to determine, for each block, whether that block is a block corresponding to the background region.

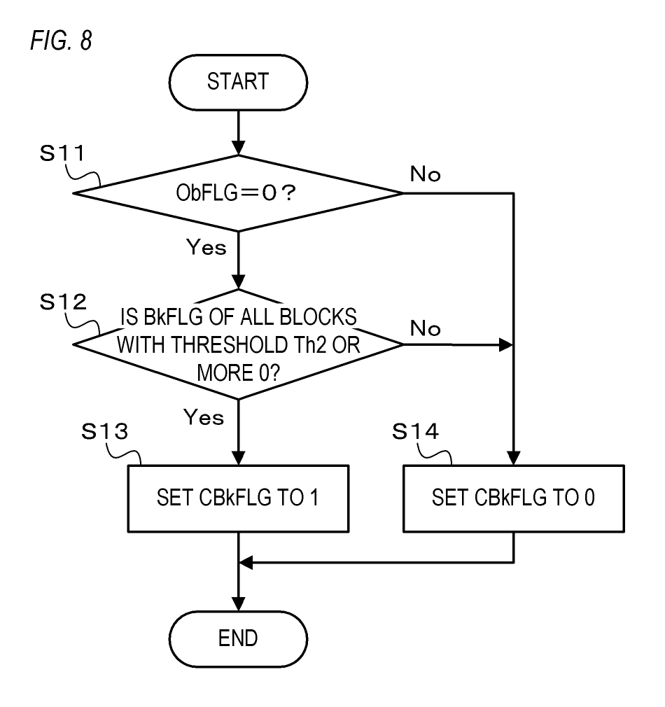

The processing flow of the lighting influence evaluation unit 5 in a case where the object region flag ObjFLG is input for each block as the object region information is now explained with reference to FIG. 8.

Foremost, the lighting influence evaluation unit 5 determines whether the object region flag ObjFLG of the block to be processed is 0 (step S11).

When the object region flag ObjFLG of the block to be processed is 0, the lighting influence evaluation unit 5 determines that the block to be processed is a block corresponding to the background region, and the processing proceeds to step S12. When the object region flag ObjFLG of the block to be processed is 1, the lighting influence evaluation unit 5 determines that the block to be processed is a block corresponding to the object region, and the processing proceeds to step S14.

In step S12, the lighting influence evaluation unit 5 refers to the lighting influence table of the block to be processed, and determines whether a block in the lighting influence table having a value that is greater than the threshold Th2 is a block corresponding to the background region. This determination is performed by confirming the object region flag ObjFLG of a block having a value that is greater than the threshold Th2.

When all blocks having a value that is greater than the threshold Th2 are blocks corresponding to the background region, the lighting influence evaluation unit 5 determines that the block to be processed is a complete background region, and the processing proceeds to step S13.

When a block other than the blocks corresponding to the background region is included in the blocks having a value that is greater than the threshold Th2, the lighting influence evaluation unit 5 determines that the block to be processed is not a complete background region, and the processing proceeds to step S14.

In step S13, the lighting influence evaluation unit 5 sets 1 in the complete background flag CBkFLG of the block to be processed.

In step S14, the lighting influence evaluation unit 5 sets 0 in the complete background flag CBkFLG of the block to be processed.

The lighting influence evaluation unit 5 performs the foregoing processing to all blocks, and outputs the complete background flag CBkFLG of all blocks.

### Embodiment 3

The display apparatus and its control method according to Embodiment 3 of the present invention is now explained. The display apparatus according to this embodiment can improve the contrast of the display image even when the backlight optical diffusion (the optical diffusion of the backlight 2) of the respective blocks is large, and can display the image of the object region in a manner that is faithful to the input image signal.

In a case where the backlight optical diffusion of the respective blocks is large, if the backlight emission brightness of one block (notable block) increases or decreases, the influence of the increase or decrease of the backlight emission brightness will extend all the way up to a considerably far block. Specifically, of the backlight emission light of the notable block, the brightness of light that leaked into a far block (block that is distant from the notable block) will become substantially flat in the foregoing far block, but will become a brightness that cannot be ignored. Thus, if the backlight emission brightness of the notable block increases or decreases, the backlight brightness of the far block will increase or decrease at a level that cannot be ignored.

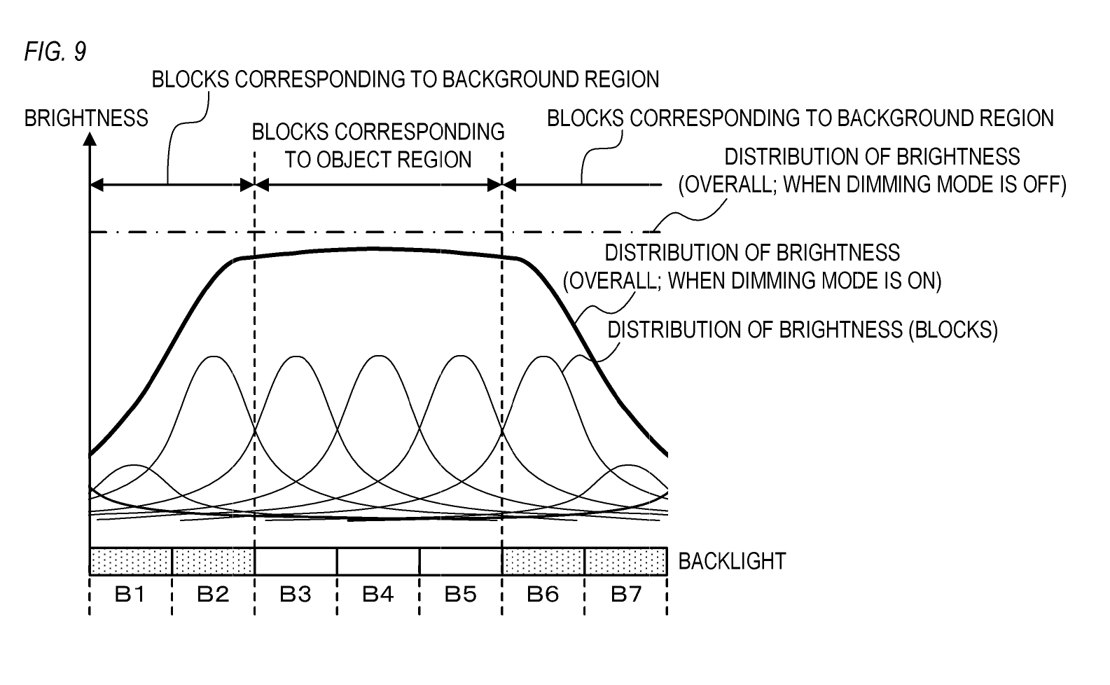

This is now explained in further detail with reference to FIG. 9. FIG. 9 is a diagram showing an example of the distribution of backlight brightness of the respective blocks and the distribution of brightness of the overall backlight. In FIG. 9, reference numerals B1 to B7 represent blocks. Blocks B1, B7 are the complete background region, blocks B2, B6 are blocks corresponding to the background region and not the complete background region, and blocks B3, B4, B5 are blocks corresponding to the object region. Blocks B2 to B6 other than the complete background region are hereinafter referred to as the incomplete background region. Note that, in this embodiment, while the plurality of blocks are arranged two-dimensionally (in a matrix), for the explanation of FIG. 9, it is assumed that the plurality of blocks are arranged one-dimensionally.

The thin line (solid line) of FIG. 9 shows the distribution of backlight brightness of the respective blocks. Specifically, the distribution of backlight brightness of the blocks B2 to B6 is the distribution when the backlight emission brightness of those blocks is set as the first emission brightness. The distribution of backlight brightness of the blocks B1, B7 is the distribution when the backlight emission brightness of those block is set to the second emission brightness (roughly ⅓ of the first emission brightness).

The heavy line (solid line) of FIG. 9 is the distribution of brightness of the overall backlight, and is a result of synthesizing the distribution of backlight brightness of each of the foregoing blocks. In other words, the heavy line (solid line) of FIG. 9 is the distribution of brightness of the overall backlight during the dimming ON mode of Embodiment 1. The dashed line of FIG. 9 is the distribution of brightness of the overall backlight when the backlight emission brightness of the respective blocks is the first emission brightness. In other words, the dashed line of FIG. 9 is the distribution of brightness of the overall backlight during the dimming OFF mode.

In FIG. 9, with the distribution of brightness shown with the heavy line, while the brightness is flat in the object region, this brightness is lower than the brightness shown with the dashed line. This is a result of lowering the backlight emission brightness of the blocks A, G.

Accordingly, when the backlight optical diffusion of the respective blocks is large, while backlight emission light of a block that is far removed from the blocks corresponding to the object region will not affect the flatness of backlight brightness in the object region, it will affect the absolute value of backlight brightness in the object region. Thus, the backlight brightness of the object region will change in the dimming ON mode and the dimming OFF mode, and, consequently, the display brightness of the object region will change in the dimming ON mode and the dimming OFF mode.

Thus, in this embodiment, the backlight emission brightness is controlled so that the backlight brightness of the object region will coincide in the dimming OFF mode and the dimming ON mode.

Note that, in this embodiment also, signal correction processing is not performed to the image signal of the blocks corresponding to the object region.

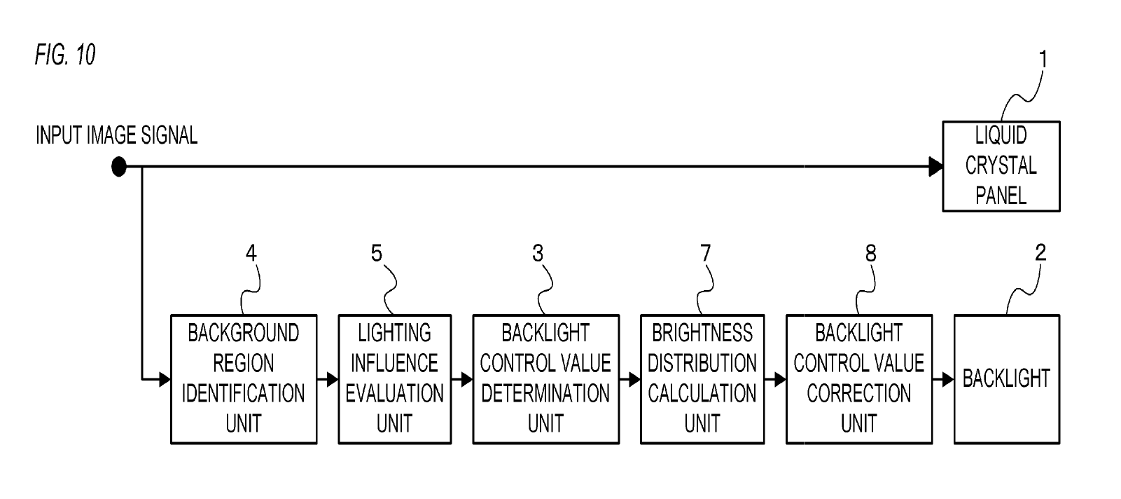

FIG. 10 is a block diagram showing an example of the functional configuration of the liquid crystal display apparatus according to this embodiment. The same reference numeral is given to the same function of Embodiment 1 (FIG. 1), and the explanation thereof is omitted.

In this embodiment, the backlight emission brightness is controlled by the backlight controlling value determination unit 3, the brightness distribution calculation unit 7, and the backlight controlling value correction unit 8. Specifically, by these functions, when the operation mode is the dimming ON mode, the backlight emission brightness (first level and third level) of the incomplete background region is determined so that the backlight brightness of the object region will coincide with the backlight brightness during the dimming OFF mode.

The backlight controlling value determination unit 3 performs the same processing as Embodiment 1. In this embodiment, as with Embodiment 1, the backlight controlling value determination unit 3 sets the backlight controlling value of the complete background region to Bk, and sets the backlight controlling value of the other blocks (incomplete background region) to W.

The brightness distribution calculation unit 7 obtains the backlight brightness of the respective blocks when the light sources of all blocks is lit with the backlight controlling value determined by the backlight controlling value determination unit 3. In this embodiment, the backlight brightness of the respective blocks when the complete background region is lit at Bk and the incomplete background region is lit at W is obtained. Here, the “backlight brightness” may be obtained for each position, or obtained for each block. For example, the average value, maximum value, minimum value, modal value or the like of the backlight brightness in the block may be obtained as the “backlight brightness”. The distribution of backlight brightness in the block may also be obtained as the “backlight brightness”.

For example, the brightness distribution calculation unit 7 stores, for each block, the lighting influence table shown in FIG. 5. In addition, by integrating, for each block, the backlight controlling value and the lighting influence table of that block, the distribution of backlight brightness when the light source of the respective blocks is independently lit is calculated. Subsequently, the brightness distribution calculation unit 7 calculates the distribution of brightness of the overall backlight by superposing the distribution (distribution calculated above) of backlight brightness when the light source of the respective blocks is independently lit. Subsequently, the brightness distribution calculation unit 7 obtains the backlight brightness of the respective blocks from the calculated distribution of brightness of the overall backlight.

The backlight controlling value correction unit 8 calculates the variation of backlight brightness of the blocks corresponding to the object region calculated by the brightness distribution calculation unit 7 relative to the backlight brightness during the dimming OFF mode. In addition, the backlight controlling value correction unit 8 corrects the backlight controlling value based on the calculation result (variation; amount of change), and outputs the result to the backlight 2. In this embodiment, the backlight controlling value correction unit 8 corrects, based on the foregoing variation, the backlight controlling value of the incomplete background region so that the backlight brightness of the object region coincides with the backlight brightness during the dimming OFF mode. In addition, the backlight controlling value correction unit 8 outputs the value determined by the backlight controlling value determination unit 3 as the backlight controlling value of the complete background region, and outputs the foregoing corrected value as the backlight controlling value of the incomplete background region.

Specifically, the backlight controlling value correction unit 8 calculates the backlight controlling value after correction as follows.

Foremost, the backlight controlling value correction unit 8 obtains the average value Lav of backlight brightness of the object region (blocks in which the background region identification unit set 0 in BkFLG) from the backlight brightness of the respective blocks calculated by the brightness distribution calculation unit 7.

Subsequently, based on Formula 1 below, the backlight controlling value correction unit 8 calculates the variation R of the backlight brightness of the blocks corresponding to the object region calculated by the brightness distribution calculation unit 7 relative to the backlight brightness during the dimming OFF mode. In Formula 1, Lt represents the average value of backlight brightness for each block during the dimming OFF mode (when all blocks (light sources of all blocks) are lit with the backlight controlling value W). Lbk represents the average value of backlight brightness for each block when all blocks are lit with the backlight controlling value Bk. Lt and Lbk may be calculated upon calculating the corrected backlight controlling value, or stored in advance.

R=(Lt−Lbk)/(Lav−Lbk) (Formula 1)

In addition, based on Formula 2 below, the backlight controlling value correction unit 8 calculates the corrected backlight controlling value Wnew of the incomplete background region.

Wnew=(W−Bk)×R+Bk (Formula 2)

With the backlight 2, the light source of the incomplete background region is lit with the emission brightness according to Wnew, and the light source of the complete background region is lit with the emission brightness according to Bk.

Note that, in Formula 1, the reason why Lbk is deducted from Lt, Lav is in order to correct the backlight emission brightness of the object region without changing the backlight emission brightness of the background region. Even if the ratio of Lt and Lay is simply calculated and the correction is performed by multiplying the backlight controlling value of all blocks by such ratio, it is possible to cause the backlight brightness of the object region to coincide with the backlight brightness during the dimming OFF mode. Thus, such a configuration may also be adopted. Nevertheless, in the case of such a configuration, the backlight emission brightness of the background region will change. For example, when the background region is a region that is darker than the object region, since the backlight emission brightness of the background region is increased, the contrast will decrease. As a result of performing the correction based on Formula 1 and Formula 2 as described above, it is possible to cause the backlight brightness of the object region to coincide with the backlight brightness during the dimming OFF mode without decreasing the contrast.

As explained above, according to this embodiment, when the operation mode is the dimming ON mode, the backlight emission brightness of the incomplete background region is determined so that the backlight brightness of the object region will coincide with the backlight brightness during the dimming OFF mode. Consequently, in addition to being able to obtain an effect that is in line with the effect of Embodiment 1, it is possible to cause the backlight brightness of the object region during the dimming ON mode to coincide with the backlight brightness during the dimming OFF mode.

Note that, in this embodiment, while a case was explained where the first level and the third level are the same level, the first level and the third level may also be different. For example, when the image processing of Embodiment 4 described later is performed, the first level and the third level will become different values. In the foregoing case, for example, the backlight controlling value of the first level after correction maybe calculated by substituting the initial value of the backlight controlling value of the first level with W of Formula 2. Moreover, the backlight controlling value of the third level after correction maybe calculated by substituting the initial value of the backlight controlling value of the third level with W of Formula 2.

### Embodiment 4

The display apparatus and its control method according to Embodiment 4 of the present invention is now explained. The display apparatus according to this embodiment performs image processing to the input image signal.

Since image processing generally contains errors, it would be desirable not to perform image processing to the image signal of an object region. Nevertheless, in order to cause the backlight brightness of the object region to be flat (uniform) without performing image processing to the image signal of the object region, it is necessary to mutually equalize the backlight emission brightness of the blocks corresponding to the background region positioned around the blocks corresponding to the object region, and the backlight of the blocks corresponding to the object region. For example, when the background region is darker than the object region, it is necessary to increase the backlight emission brightness of the blocks corresponding to the background region positioned around the blocks corresponding to the object region to be the same backlight emission brightness as the backlight emission brightness of the block corresponding to the object region. In the case of a backlight having a large optical diffusion, the contract improvement effect will decrease since the backlight emission brightness of the block corresponding to the background region needs to be mutually equalized with the backlight emission brightness of the block corresponding to the object region on a widespread basis.

Nevertheless, depending on the image, there are cases where priority should be given to the contract improvement effect of the overall image rather than the signal fidelity of the outer edge of the object region (boundary with the background region). For example, in the case of an image where the user would focus attention at the center of the object region and the background region includes a graphic image for operating the image of the object region, the contract improvement effect of the overall image should be given preference rather than the signal fidelity of the outer edge of the object region. This embodiment is effective in the foregoing case.

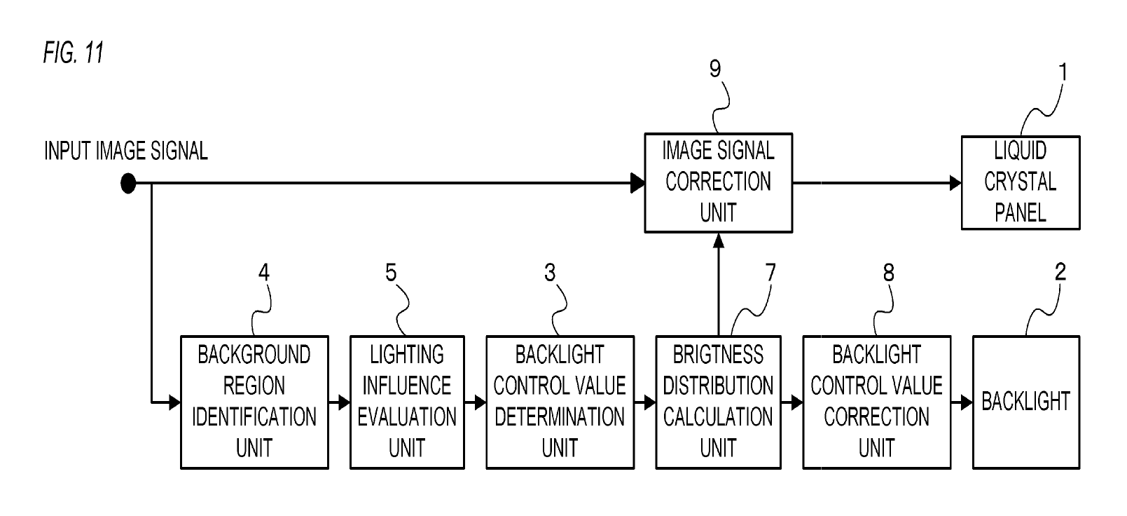

FIG. 11 is a block diagram showing an example of the functional configuration of the liquid crystal display apparatus according to this embodiment. The same reference numeral is given to the same function as Embodiment 3 (FIG. 10), and the explanation thereof is omitted.

The image signal correction unit 9 performs image processing to the input image signal (input image signal to be displayed in the block corresponding to the object region) so that the backlight brightness of the object region becomes flat when the operation mode is the dimming ON mode. Specifically, the image signal correction unit 9 calculates the correction value used for the correction of the input image signal from the backlight brightness of the respective blocks calculated by the brightness distribution calculation unit 7, and corrects the input image signal by using the calculated correction value. The correction value is, for example, a reciprocal of the ratio of the backlight brightness of the block corresponding to the object region calculated by the brightness distribution calculation unit 7 relative to the backlight brightness during the dimming OFF mode.

In Embodiments 1 to 3, in order to inhibit the backlight brightness of the blocks corresponding to the object region from becoming uneven, the backlight emission brightness of the blocks corresponding to the background region positioned around the blocks corresponding to the object region was caused to be equal to the backlight emission brightness of the blocks corresponding to the object region. In other words, the third level was caused to have the same value as the first level. Thus, when the background region is darker than the object region, it was not possible to lower the backlight emission brightness of the blocks corresponding to the background region positioned around the blocks corresponding to the object region.

Meanwhile, in this embodiment, the input image signal is corrected so that the backlight emission brightness of the blocks corresponding to the background region positioned around the blocks corresponding to the object region approaches the backlight emission brightness of the blocks corresponding to the object region, and the backlight brightness of the object region becomes flat. Consequently, it is possible to cause the backlight emission brightness of the blocks corresponding to the background region positioned around the blocks corresponding to the object region to approach the backlight emission brightness of the complete background region. Specifically, since the input image signal is corrected to a certain degree so that the backlight brightness of the object region becomes flat, in comparison to a case where no correction is performed at all, it is possible to cause the backlight emission brightness of the blocks corresponding to the background region positioned around the blocks corresponding to the object region to approach the backlight emission brightness of the complete background region. In other words, it is possible to increase the value of the threshold Th2 described in Embodiment 1 (influential range described in Embodiment 1 can be narrowed).

Note that, in this embodiment, since the backlight emission brightness of the object region is mutually equalized, only the input image signal of the blocks displayed at the outer edge of the object region is subject to image processing.

Accordingly, by the foregoing image processing, while the signal fidelity of the outer edge of the object region will deteriorate in comparison to Embodiments 1 to 3, it is possible to realize a high signal fidelity regarding the main portion (center portion) of the object region.

As described above, according to this embodiment, when the operation mode is the dimming ON mode, image processing is performed to the input image signal so that the backlight brightness of the object region becomes flat. Consequently, in addition being able to obtain an effect that is in line with the effect of Embodiments 1 to 3, it is also possible to cause the backlight emission brightness of the blocks corresponding to the background region positioned around the blocks corresponding to the object region to approach the second level, and thereby further improve the contrast.

Note that, in this embodiment, while the backlight controlling value was determined with the same method as Embodiment 3, the backlight controlling value may also be determined with the method of Embodiments 1 and 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-277626, filed on Dec. 19, 2011, and Japanese Patent Application No. 2012-257481, filed on Nov. 26, 2012, which are hereby incorporated by reference herein in their entirety.

What is claimed is:

1. A display apparatus capable of controlling a backlight emission brightness for each block obtained by dividing an image,
the display apparatus comprising:
a determination unit that determines, for each block corresponding to a background region, which is a region of a background in an image based on an input image signal, whether the block is a block which satisfies a predetermined condition; and
a control unit that controls the backlight emission brightness of each of the blocks based on a determination result of the determination unit, wherein
when a block corresponding to an object region, which is a region of a predetermined object in an image based on an input image signal, is not included in a predetermined number of blocks centered around a determination-target block, the determination unit determines that the determination-target block is a block which satisfies the predetermined condition, and wherein
the control unit:
sets a backlight emission brightness of a block corresponding to the object region to a first level,
sets a backlight emission brightness of a block which satisfies the predetermined condition, among the blocks corresponding to the background region, to a second level that is lower than the first level, and
sets a backlight emission brightness of a block which does not satisfy the predetermined condition, among the blocks corresponding to the background region, to a third level that is higher than the second level and not higher than the first level.

2. The display apparatus according to claim 1, wherein, when the block corresponding to the object region is not included in P×P (P is an integer of 3 or higher) number of blocks centered around a determination-target block, the determination unit determines that the determination-target block is a block which satisfies the predetermined condition.

3. The display apparatus according to claim 1, wherein, upon using a table showing an influence level of a backlight emission light of a determination-target block with regard to peripheral blocks, when the block corresponding to the object region is not included among blocks in which the influence level of the backlight emission light is greater than a predetermined threshold, the determination unit determines that the determination-target block is a block which satisfies the predetermined condition.

4. The display apparatus according to claim 1, further comprising:
an image processing unit that performs image processing to the input image signal so that a backlight brightness of the object region becomes flat.

5. The display apparatus according to claim 1, further comprising: a background region determination unit that determines, for each block, whether the block is a block corresponding to the background region, wherein
for each block, when the input image signal displayed in that block includes more than a predetermined number of pixels having a pixel value that is a predetermined value or less, the background region determination unit determines that that block is a block corresponding to the background region.

6. The display apparatus according to claim 1, further comprising:
a background region determination unit that determines, for each block, whether the block is a block corresponding to the background region, wherein
the background region determination unit determines that a block in which an image of the object region is not displayed is a block corresponding to the background region based on information representing a display region of an image of an object region input from an external apparatus.

7. The display apparatus according to claim 1, wherein
as an operation mode, included are a dimming ON mode for controlling the backlight emission brightness for each block, and a dimming OFF mode for mutually equalizing the backlight emission brightness of all blocks, and wherein
when the operation mode is the dimming ON mode, the control unit sets the first level and the third level so that a backlight brightness of the object region coincides with a backlight brightness during the dimming OFF mode.

8. The display apparatus according to claim 1, wherein the control unit sets a backlight emission brightness of a block which has been determined as not satisfying the predetermined condition to, when an area of an image of the object region displayed in the block corresponding to the object region among the predetermined number of blocks centered around that block is small, a level that is lower than in a case where the area is large.

9. The display apparatus according to claim 1, wherein the object region is a region of a diagnosis image.

10. A control method of a display apparatus capable of controlling a backlight emission brightness for each block obtained by dividing an image,
the method comprising:
a determination step of determining, for each block corresponding to a background region, which is a region of a background in an image based on an input image signal, whether the block is a block which satisfies a predetermined condition; and
a control step of controlling the backlight emission brightness of each of the blocks based on a determination result in the determination step, wherein
in the determination step, when a block corresponding to an object region, which is a region of a predetermined object in an image based on an input image signal, is not included in a predetermined number of blocks centered around a determination-target block, determination is made that the determination-target block is a block which satisfies the predetermined condition, and wherein
in the control step, a backlight emission brightness of a block corresponding to the object region is set to a first level,
a backlight emission brightness of a block which satisfies the predetermined condition among the blocks corresponding to the background region is set to a second level that is lower than the first level, and
a backlight emission brightness of a block which does not satisfy the predetermined condition among the blocks corresponding to the background region is set to a third level that is higher than the second level and not higher than the first level.

11. The control method of a display apparatus according to claim 10,
wherein, in the determination step, when the block corresponding to the object region is not included in P×P (P is an integer of 3 or higher) number of blocks centered around a determination-target block, determination is made that the determination-target block is a block which satisfies the predetermined condition.

12. The control method of a display apparatus according to claim 10, wherein, in the determination step, upon using a table showing an influence level of a backlight emission light of a determination-target block with respect to peripheral blocks, when the block corresponding to the object region is not included among blocks in which the influence level of the backlight emission light is greater than a predetermined threshold, determination is made that the determination-target block is a block which satisfies the predetermined condition.

13. The control method of a display apparatus according to claim 10, further comprising: an image processing step of performing image processing to the input image signal so that a backlight brightness of the object region becomes flat.

14. The control method of a display apparatus according to claim 10, further comprising: a background region determination step of determining, for each block, whether the block is a block corresponding to the background region, wherein
in the background region determination step, for each block, when the input image signal displayed in the block includes at least a predetermined number of pixels having a pixel value that is a predetermined value or less, determination is made that the block is a block corresponding to the background region.

15. The control method of a display apparatus according to claim 10, further comprising:
a background region determination step of determining, for each block, whether the block is a block corresponding to the background region, wherein
in the background region determination step, determination is made that a block in which an image of the object region is not displayed is a block corresponding to the background region based on information representing a display region of an image of an object region input from an external apparatus.

16. The control method of a display apparatus according to claim 10,
wherein, as an operation mode, the display apparatus includes a dimming ON mode for controlling the backlight emission brightness for each block, and a dimming OFF mode for mutually equalizing the backlight emission brightness of all blocks, and
in the control step, when the operation mode is the dimming ON mode, the first level and the third level are set so that a backlight brightness of the object region coincides with a backlight brightness during the dimming OFF mode.

17. The control method of a display apparatus according to claim 10,
wherein, in the control step, a backlight emission brightness of a block which has been determined as not satisfying the predetermined condition is set to, when an area of an image of the object region displayed in the block corresponding to the object region among the predetermined number of blocks centered around that block is small, a level that is lower than in a case where the area is large.

18. The control method of a display apparatus according to claim 10, wherein the object region is a region of a diagnosis image.
